(19) United States
(12) Patent Application Publication
(10) Pub. No.: US 2020/0299448 A1
(43) Pub. Date: Sep. 24, 2020

(54) SYNTHESIS METHOD FOR HIGH WEATHER-RESISTANT RED WATER-BASED POLYURETHANE EMULSION

(71) Applicant: HUAIYIN INSTITUTE OF TECHNOLOGY, Huaian (CN)

(72) Inventors: Yu MAO, Huaian (CN); Lingli NI, Huaian (CN); Yongtao LIU, Huaian (CN); Xiaoyan GAO, Huaian (CN); Peng CAI, Huaian (CN); Jing CHENG, Huaian (CN); Guijun LI, Huaian (CN)

(21) Appl. No.: 16/771,347

(22) PCT Filed: Jan. 8, 2019
(86) PCT No.: PCT/CN2019/070724

§ 371 Date: Jun. 10, 2020

(30) Foreign Application Priority Data
Aug. 28, 2018 (CN) 201810988256.6

(51) Int. Cl. C08G 18/10; C08G 18/42; C08K 3/34; C08G 18/22

(52) U.S. Cl. CPC C08G 18/10; C08G 18/4202; C08G 18/227; C08K 3/346; C08G 18/4238

(57) ABSTRACT

The present invention relates to the field of chemical industries, and discloses a method for synthesizing a highly weather-resistant red waterborne polyurethane emulsion, including using oligomeric diol, aliphatic diisocyanate, iron-rich red attapulgite clay, and a hydrophilic chain extender for stepwise polymerization to synthesize a red attapulgite clay modified hydrophilic polyurethane prepolymer, then self-emulsifying and dispersing in metered water, and then adding a small molecule diamine chain extender for chain extension to obtain a red attapulgite clay modified red waterborne polyurethane emulsion. The preparation method of the present invention is easy to operate, energy-saving and environmentally friendly. The prepared red waterborne polyurethane emulsion has a solid content>30 wt. % and the pH between 6.0 and 7.0, and its coating product has the advantages of good water resistance, high weather resistance, vivid color, etc., and has a broad market prospect.

### TECHNICAL FIELD

The present invention relates to the technical field of chemical industries, and in particular, to a method for synthesizing a highly weather-resistant red waterborne polyurethane emulsion.

### BACKGROUND

Waterborne polyurethane has been widely applied to industries such as coatings, leather, adhesives, inks, and buildings due to its outstanding environmental protection advantages and excellent comprehensive properties. However, a small molecule dye is generally used to obtain a colored waterborne polyurethane product. Generally, the small molecule dye is usually bonded to the waterborne polyurethane through ionic bonding, hydrogen bonding, a van der Waals force, etc., and therefore, the force of bonding with polyurethane is not strong, and it is easy to migrate to the surface of the material during placement, washing, dry cleaning, use, etc., causing constant shedding and fading. In addition, due to the need to achieve good dispersion of a waterborne polyurethane resin in water, a hydrophilic group is introduced into its chain segment during the synthesis of a waterborne polyurethane emulsion, resulting in that the obtained waterborne polyurethane product has shortcomings such as poor water resistance, abrasion resistance and heat resistance and low mechanical strength, thus seriously hindering its application.

### SUMMARY

Technical Problem: to solve the problems in the prior art, the present invention provides a method for synthesizing a highly weather-resistant red waterborne polyurethane emulsion. By introducing iron-rich red attapulgite clay as a pigment into the molecular chain of waterborne polyurethane through concise organic synthesis steps, the mechanical properties and weather resistance, etc. of the obtained waterborne polyurethane leather product are improved.

Technical Solution: the present invention provides a method for synthesizing a highly weather-resistant red waterborne polyurethane emulsion. The following raw materials are weighed in percentage by weight: 5-20% of red attapulgite clay, 5-25% of oligomeric diol, 20-60% of diisocyanate, 0-10% of hydrophilic chain extender, 0-10% of small molecule diamine chain extender, 0-1% of organic bismuth catalyst, 10-20% of acetone and the balance of water. The synthesis steps are as follows: S1: preparation of a red attapulgite clay modified hydrophilic polyurethane prepolymer: stirring the diisocyanate and the oligomeric diol to react at 80° C. for 0.5-2 h, adding the red attapulgite clay, stirring to react for 1 h, then adding the hydrophilic chain extender, stirring to react for 0.5-1 h, adding the organic bismuth catalyst, continuing stirring to react for 1.5 h, adding acetone, continuing stirring to react for another 1.5 h, then adding water and stirring at a high speed to self-emulsify and disperse, to obtain the red attapulgite clay modified hydrophilic polyurethane prepolymer; S2: secondary chain extension: adding the small molecule diamine chain extender to the hydrophilic polyurethane prepolymer, then raising the temperature to 50° C. to perform chain extension for 4-8 h; and S3: acetone removal: after a system becomes a homogeneous emulsion, removing the acetone at 50° C. and 0.1 MPa to obtain a red attapulgite clay modified red waterborne polyurethane emulsion.

Preferably, the red attapulgite clay is activated red attapulgite clay obtained after a natural iron-rich attapulgite clay mineral is activated by boiling water to remove impurities and dried. The activated red attapulgite clay has more silicon hydroxyl on the surface, facilitating the reaction of the attapulgite clay with the isocyanate, so that the attapulgite clay can be better compounded with polyurethane, so as to obtain more excellent mechanical properties and color fastness.

Further, the specific preparation steps of the activated red attapulgite clay are as follows: adding ≥200-mesh natural iron-rich red attapulgite clay to boiling water, performing activation treatment for 12-24 h, filtering, drying at 75-85° C., and then crushing to obtain the activated red attapulgite clay with a large amount of silicon hydroxyl on the surface.

Preferably, the mass-volume ratio of the natural iron-rich red attapulgite clay to the boiling water is 100 g:500-2000 mL.

Preferably, the hydrophilic chain extender is a carboxyl-containing small molecule diol hydrophilic chain extender.

Preferably, the oligomeric diol is any one or a combination of the following: polyneopentyl glycol adipate diol, polyethylene-propylene adipate diol, or polyethylene-1,4-buthylene adipateglycol.

Preferably, the diisocyanate is any one or a combination of the following: isophorone diisocyanate, hexamethylene diisocyanate, 4,4′-dicyclohexyl methane diisocyanate, or methylcyclohexyl diisocyanate.

Advantageous Effect: compared with the prior art, the present invention has the following advantages:

1. The iron-rich red attapulgite clay modified red waterborne polyurethane emulsion provided by the present invention has a bright color, good weather resistance and a simple preparation process, is environmentally friendly, and is suitable for industrial production.

2. Iron-rich attapulgite clay pigment modified waterborne polyurethane is prepared by the chain extension reaction of isocyanate with the silicon hydroxyl on the surface of red attapulgite clay, so that the dispersion of the red attapulgite clay pigment at a micro-nano level on a polyurethane chain segment can be achieved, so as to increase its compatibility with a polyurethane resin, facilitating improving the stability of the emulsion, thus facilitating storage and transportation.

3. The product prepared by using the waterborne polyurethane of the present invention has no solvent residue, good color fastness, strong weather resistance, excellent water resistance, heat resistance and abrasion resistance, etc.

### DETAILED DESCRIPTION

The present invention is described in detail below with reference to specific embodiments.

### Embodiment 1

This embodiment provides a method for synthesizing a highly weather-resistant red waterborne polyurethane emulsion. The following raw materials are weighed in percentage by weight: 5% of activated red attapulgite clay, 20% of polyneopentyl glycol adipate diol, 20% of isophorone diisocyanate, 10% of dimethylol propionic acid, 10% of ethylenediamine, 1% of organic bismuth catalyst, 10% of acetone and the balance of water.

The synthesis steps are as follows:

S1: Preparation of Activated Red Attapulgite Clay:
adding 100 g of ≥200-mesh natural iron-rich red attapulgite clay to 2,000 mL of boiling water, performing activation treatment for 12 h, filtering, performing freeze drying, and then crushing to obtain the activated red attapulgite clay with a large amount of silicon hydroxyl on the surface;

S2: Preparation of a Red Attapulgite Clay Modified Hydrophilic Polyurethane Prepolymer:

stirring the isophorone diisocyanate and the polyneopentyl glycol adipate diol to react at 80° C. for 0.5 h, adding the activated red attapulgite clay prepared in S1, stirring to react for 1 h, adding the dimethylol propionic acid, stirring to react for 0.5 h, then adding the organic bismuth catalyst, continuing stirring to react for 1.5 h, adding the acetone, continuing stirring to react for another 1.5 h, then adding water and stirring at a high speed to self-emulsify and disperse, to obtain the red attapulgite clay modified hydrophilic polyurethane prepolymer;

S3: Secondary Chain Extension:

adding the ethylenediamine to the hydrophilic polyurethane prepolymer, and then raising the temperature to 50° C. to perform chain extension for 4 h; and

S4: Acetone Removal:

after a system becomes a homogeneous emulsion, removing the acetone at 50° C. and 0.1 MPa to obtain a red attapulgite clay modified red waterborne polyurethane emulsion.

### Embodiment 2

This embodiment provides a method for synthesizing a highly weather-resistant red waterborne polyurethane emulsion. The following raw materials are weighed in percentage by weight: 12% of activated red attapulgite clay, 20% of polyethylene-propylene adipate diol and polyethylene-1,4-buthylene adipateglycol, 35% of isophorone diisocyanate and methylcyclohexyl diisocyanate, 20% of dimethylol butanoic acid, 15% of isophorone diamine, 1% of organic bismuth catalyst, 10% of acetone and the balance of water.

The synthesis steps are as follows:

S1: Preparation of Red Attapulgite Clay:

adding 100 g of ≥200-mesh natural iron-rich red attapulgite clay to 1,000 mL of boiling water, performing activation treatment for 18 h, filtering, performing freeze drying, and then crushing to obtain the activated red attapulgite clay with a large amount of silicon hydroxyl on the surface;

S2: Preparation of a Red Attapulgite Clay Modified Hydrophilic Polyurethane Prepolymer:

stirring the isophorone diisocyanate and methylcyclohexyl diisocyanate and the polyethylene-propylene adipate diol and polyethylene-1,4-buthylene adipateglycol to react at 80° C. for 1 h, adding the activated red attapulgite clay prepared in S1, stirring to react for 1 h, adding the dimethylol butanoic acid, stirring to react for 1 h, then adding the organic bismuth catalyst, continuing stirring to react for 1.5 h, adding the acetone, continuing stirring to react for another 1.5 h, then adding water and stirring at a high speed to self-emulsify and disperse, to obtain the red attapulgite clay modified hydrophilic polyurethane prepolymer;

S3: Secondary Chain Extension:

adding the isophorone diamine to the hydrophilic polyurethane prepolymer, and then raising the temperature to 50° C. to perform chain extension for 8 h; and

S4: Acetone Removal:

after a system becomes a homogeneous emulsion, removing the acetone at 50° C. and 0.1 MPa to obtain a red attapulgite clay modified red waterborne polyurethane emulsion.

### Embodiment 3

This embodiment provides a method for synthesizing a highly weather-resistant red waterborne polyurethane emulsion. The following raw materials are weighed in percentage by weight: 20% of activated red attapulgite clay, 10% of polyneopentyl glycol adipate diol and polyethylene-propylene adipate diol, 30% of isophorone diisocyanate and 4,4′-dicyclohexyl methane diisocyanate as well as methylcyclohexyl diisocyanate, 10% of dimethylol propionic acid, 10% of ethylenediamine and isophorone diamine, 0.5% of organic bismuth catalyst, 10% of acetone and the balance of water.

The synthesis steps are as follows:

S1: Preparation of Activated Red Attapulgite Clay:

adding 100 g of ≥200-mesh natural iron-rich red attapulgite clay to 500 mL of boiling water, performing activation treatment for 24 h, filtering, performing freeze drying, and then crushing to obtain the activated red attapulgite clay with a large amount of silicon hydroxyl on the surface;

S2: Preparation of a Red Attapulgite Clay Modified Hydrophilic Polyurethane Prepolymer:

stirring the isophorone diisocyanate and 4,4′-dicyclohexyl methane diisocyanate as well as methylcyclohexyl diisocyanate and the polyneopentyl glycol adipate diol and polyethylene-propylene adipate diol to react at 80° C. for 2 h, adding the activated red attapulgite clay prepared in S1, stirring to react for 1 h, adding the dimethylol propionic acid, stirring to react for 1 h, then adding the organic bismuth catalyst, continuing stirring to react for 1.5 h, adding the acetone, continuing stirring to react for another 1.5 h, then adding water and stirring at a high speed to self-emulsify and disperse, to obtain the red attapulgite clay modified hydrophilic polyurethane prepolymer;

S3: Secondary Chain Extension:

adding the ethylenediamine and isophorone diamine to the hydrophilic polyurethane prepolymer, and then raising the temperature to 50° C. to perform chain extension for 6 h; and

S4: Acetone Removal:

after a system becomes a homogeneous emulsion, removing the acetone at 50° C. and 0.1 MPa to obtain a red attapulgite clay modified red waterborne polyurethane emulsion.

The weather resistance, water resistance, and abrasion resistance of the red waterborne polyurethane emulsion prepared by the methods in the above embodiments are respectively tested in the following manner.

Weather resistance: according to GB/T 16422.2-2014, after the red waterborne polyurethane emulsion is made into a thin film, an aging time test, i.e., weather resistance test, is performed under the irradiation of a UV xenon lamp (500 W).

Water resistance: the red waterborne polyurethane emulsion is made into a thin film with the thickness of about 1 mm on a tetrafluoroethylene board, after completely dried, the thin film is immersed in 25° C. deionized water for 24 h, and the change in the total amount of the thin film before and after the immersion is checked.

Abrasion resistance: after the red waterborne polyurethane emulsion is made into a thin film, the number of worn circles is tested on a TABER friction tester by using an H22 grinding wheel.

The weather resistance, water resistance, and abrasion resistance red tests are performed on the waterborne polyurethane emulsions obtained in Embodiments 1, 2, and 3, and the results are as follows:

| | Weather | Hydrolysis | Abrasion |
|---|---|---|---|
| | resistance | resistance | resistance |
| | (h) | (Weight loss %) | (Turns) |
| Embodiment 1 | 800 | 0.1 | 7000 |
| Embodiment 2 | 1100 | 0.07 | 7200 |
| Embodiment 3 | 1100 | 0.08 | 6800 |

The above embodiments are merely intended to describe the technical concepts and features of the present invention, aim at enabling a person of ordinary skill in the art to understand and implement the content of the present invention, but are not intended to limit the scope of protection of the present invention. Equivalent variations or modifications made according to the essence of the present invention shall fall within the scope of protection of the present invention.

1. A method for synthesizing a highly weather-resistant red waterborne polyurethane emulsion, wherein the following raw materials are weighed in percentage by weight: 5-20% of red attapulgite clay, 5-25% of oligomeric diol, 20-60% of diisocyanate, 0-10% of hydrophilic chain extender, 0-10% of small molecule diamine chain extender, 0-1% of organic bismuth catalyst, 10-20% of acetone and the balance of water;
the synthesis steps are as follows:
S1: preparation of a red attapulgite clay modified hydrophilic polyurethane prepolymer:
stirring the diisocyanate and the oligomeric diol to react at 80° C. for 0.5-2 h, adding the red attapulgite clay, stirring to react for 1 h, then adding the hydrophilic chain extender, stirring to react for 0.5-1 h, adding the organic bismuth catalyst, continuing stirring to react for 1.5 h, adding acetone, continuing stirring to react for another 1.5 h, then adding water and stirring at a high speed to self-emulsify and disperse, to obtain the red attapulgite clay modified hydrophilic polyurethane prepolymer;
S2: secondary chain extension:
adding the small molecule diamine chain extender to the hydrophilic polyurethane prepolymer, then raising the temperature to 50° C. to perform chain extension for 4-8 h; and
S3: acetone removal:
after a system becomes a homogeneous emulsion, removing the acetone at 50° C. and 0.1 MPa to obtain a red attapulgite clay modified red waterborne polyurethane emulsion.

2. The method for synthesizing a highly weather-resistant red waterborne polyurethane emulsion according to claim 1, wherein the red attapulgite clay is activated red attapulgite clay obtained after a natural iron-rich attapulgite clay mineral is activated by boiling water to remove impurities and dried.

3. The method for synthesizing a highly weather-resistant red waterborne polyurethane emulsion according to claim 2, wherein the specific preparation steps of the activated red attapulgite clay are as follows: adding ≥200-mesh natural iron-rich red attapulgite clay to boiling water, performing activation treatment for 12-24 h, filtering, drying at 75-85° C., and then crushing to obtain the activated red attapulgite clay with a large amount of silicon hydroxyl on the surface.

4. The method for synthesizing a highly weather-resistant red waterborne polyurethane emulsion according to claim 3, the mass-volume ratio of the natural iron-rich red attapulgite clay to the boiling water is 100 g:500-2000 mL.

5. The method for synthesizing a highly weather-resistant red waterborne polyurethane emulsion according to claim 1, wherein the hydrophilic chain extender is a carboxyl-containing small molecule diol hydrophilic chain extender.

6. The method for synthesizing a highly weather-resistant red waterborne polyurethane emulsion according to claim 1, wherein the oligomeric diol is any one or a combination of the following:
polyneopentyl glycol adipate diol, polyethylene-propylene adipate diol, or polyethylene-1,4-buthylene adipateglycol.

7. The method for synthesizing a highly weather-resistant red waterborne polyurethane emulsion according to claim 1, wherein the diisocyanate is any one or a combination of the following:
isophorone diisocyanate, hexamethylene diisocyanate, 4,4′-dicyclohexyl methane diisocyanate, or methylcyclohexyl diisocyanate.
